(19) United States
(12) Patent Application Publication
(10) Pub. No.: US 2007/0006836 A1
(43) Pub. Date: Jan. 11, 2007

(54) Traction mechanism drive having vibration damping

(75) Inventors: Rainer Pflug, Heilsbronn (DE); Bernd Hartmann, Weisendorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/482,564

(22) Filed: Jul. 7, 2006

Related U.S. Application Data
(60) Provisional application No. 60/697,924, filed on Jul. 8, 2005.

(51) Int. Cl. F01L 1/02; F02B 75/06

(52) U.S. Cl. 123/90.31; 123/192.2

(57) ABSTRACT

Traction mechanism drive for internal combustion engines, in which traction mechanism drive additional consumers are present in addition to the driving wheel and the driven wheel, said wheels being non-circular for the purposes of vibration damping, wherein only deflecting rollers which run without load are present in the tension strand between the driven wheel and the driving wheel.

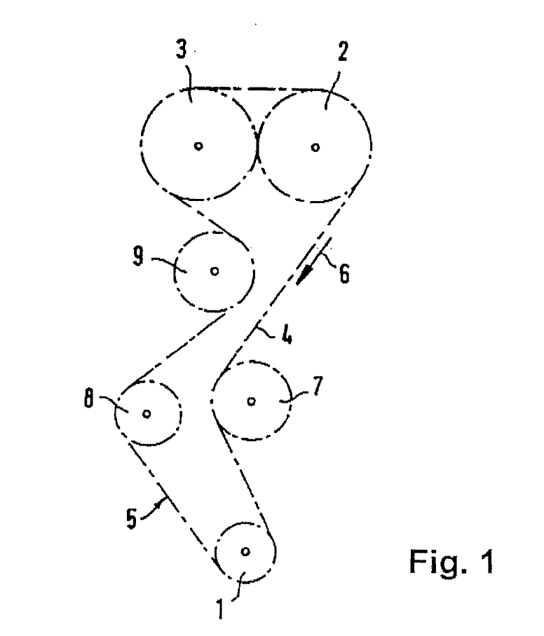

### FIELD OF THE INVENTION

The invention relates to a traction mechanism drive for internal combustion engines, in which traction mechanism drive additional consumers are present in addition to the driving wheel and the driven wheel, said wheels being non-circular for the purposes of vibration damping.

### BACKGROUND OF THE INVENTION

The driving wheel is typically on the crankshaft while the one or more driven wheels are seated on the camshaft. It is possible, by means of the driving wheel and the driven wheels being of a non-circular design which is adapted to the specific conditions, in particular the number of pistons of the engine, to obtain very good damping of vibrations and vibration fluctuations within the belt or the chain, which both contributes to considerable noise damping and also increases service life.

It has already been proposed in DE 195 20 508 A1 to provide a means which imparts an additional nonuniformity to the wraparound drive. Said nonuniformity can be generated by means of a wheel which is non-circular and/or is mounted eccentrically. Said artificially generated nonuniformities are intended to counteract the vibrational changes which are produced by combustion processes and valve movements.

If a further consumer, for example an injection pump or the like, is now also to be driven in addition to the camshaft by the same traction mechanism drive, the previously described vibration damping is, as a result, severely adversely affected, and sometimes becomes almost impossible.

### SUMMARY OF THE INVENTION

The invention is therefore based on the object of designing a traction mechanism drive of the type mentioned in the introduction having additional consumers in such a way that the ID² vibration damping measures can have an optimum effect at the driving and driven wheels despite the presence of the additional consumer.

According to the invention, to achieve said object, it is provided that only deflecting rollers which run without load are present at the tension side between the driven wheel and the driving wheel, and any additional consumers are relocated into the other branch of the drive means.

It has surprisingly been proven that injection pumps or other auxiliary units can be directly arranged in the traction mechanism drive as additional consumers, provided only that they are not situated at the tension side between the driven wheel and the driving wheel, where the force signals of n-th order would be superimposed with those of the driven and driving wheels such that the compensation and damping according to ID² would only be obtainable to an insufficient extent.

### BRIEF DESCRIPTION OF THE DRAWINGS

Further advantages, features and details of the invention can be gathered from the following description of an exemplary embodiment and on the basis of the drawing, which schematically shows a traction mechanism drive.

### DETAILED DESCRIPTION OF THE DRAWINGS

Only one deflecting roller 7 which runs without load is arranged in the tension strand 4 of the wraparound transmission 5—the arrow 6 indicates the direction of circulation of the wraparound drive—between the crankshaft 1, situated at the bottom, and the overhead camshafts 2 and 3. Any other consumers such as injection pumps, water pumps or other auxiliary units can be connected in in place of the deflecting rollers 8 and 9 in order that successful vibration damping according to ID², by means of corresponding non-circular design of the crankshaft wheel and/or of the camshaft wheels, is not adversely affected.

### REFERENCE NUMBERS

1 Crankshaft
2 Camshaft
3 Camshaft
4 Tension strand
5 Wraparound drive
6 Arrow
7 Deflecting roller
8 Deflecting roller
9 Deflecting roller

1. Traction mechanism drive for internal combustion engines, comprising: traction mechanism drive additional consumers, a driving wheel and a driven wheel, said wheels being non-circular for the purposes of vibration damping, wherein only deflecting rollers which run without load are present in a tension strand between the driven wheel and the driving wheel.
